(19) United States
(12) Patent Application Publication
(10) Pub. No.: US 2002/0069235 A1
(43) Pub. Date: Jun. 6, 2002

(54) System for allocating resources in a process system and method of operating the same

(76) Inventor: Charlie Wen-Tsann Chen, Dallas, TX (US)

Correspondence Address: William J. Munck, Esq., Novakov Davis & Munck, P.C., 900 Three Galleria Tower, 13155 Noel Road, Dallas, TX, 75240, US

(21) Appl. No.: 09/728,205

(22) Filed: Dec. 1, 2000

(51) Int. Cl. G06F 9/00; G06F 17/60

(52) U.S. Cl. 709/104; 705/7

(57) ABSTRACT

There are disclosed systems, as well as methods of operating the same, for allocating a plurality of resources, both process and human resources, among a plurality of tasks within a process system. An exemplary resource allocator is introduced that is operable to allocate a plurality of resources among a plurality of tasks within a process system, wherein the plurality of resources includes both human resources and process resources and wherein the process system includes a plurality of application processes. The resource allocator includes a memory, a status-monitoring controller, and a resource allocation controller. An exemplary memory in accord herewith is operable to store a model of the process system, wherein the model (i) represents mathematically the plurality of application processes, the plurality of resources, and the plurality of tasks, and (ii) defines various relationships among related ones thereof. An exemplary status-monitoring controller in accord herewith is operable to monitor measurable characteristics associated with ones of the process system, the application processes, the resources, and the tasks. An exemplary resource allocation controller in accord herewith, and in response to ones of the monitored measurable characteristics, is operable to: (i) modify ones of the mathematical representations and (ii) allocate ones of the resources among ones of the tasks within the process system.

### TECHNICAL FIELD OF THE INVENTION

The present invention is directed generally to resource allocation systems and, more specifically, to systems for allocating a plurality of resources among a plurality of tasks within a process system wherein the plurality of resources comprises both human resources and process resources, as well as methods of operating the same.

### BACKGROUND OF THE INVENTION

Process resource allocation is, by conventional thought, the management (i.e., control, administration, command, direction, governance, monitor, regulation, etc.) of process resources (e.g., hardware, software, databases, communication/connectivity resources, transportation resources, facilities, utilities, inventories, etc.) among a variety of tasks within a process system.

Process systems may be arranged and implemented to manage large facilities, such as a manufacturing plant, a mineral or crude oil refinery, or the like, as well as relatively smaller facilities, such as a corporate intranetwork, data repository and management system, or the like. Such systems may be distributed or not, and typically include numerous modules tailored to manage various associated processes, wherein conventional means link these modules together to produce the distributed nature of the process system. This affords increased performance and a capability to expand or reduce the process system to satisfy changing needs.

Information technology management providers develop process systems that can be tailored to satisfy wide ranges of process requirements, whether global, local or otherwise, and regardless of facility type. Such information technology management providers commonly have two principles objectives, (i) to centralize control of as many processes as possible to improve overall efficiency and (ii) to support a common interface that communicates data among various modules controlling or monitoring the processes, and also with any such centralized controller.

Each process, or group of associated processes, has certain input (e.g., data, diagnostics, flow, feed, power, etc.) and output (e.g., data, utilization parameters, temperature, pressure, etc.) characteristics associated with it. These characteristics are measurable such input and out put values may be measured, represented in a discernable manner. In recent years, predictive control techniques have been used to optimize certain processes as a function of such characteristics in short, modeling and allocating process resources in response to the same. Predictive control techniques may use algorithmic representations of certain processes to estimate characteristic values (represented as parameters, variables, etc.) associated with them that can be used to better manage, particularly allocation, of such process resources among a plurality of tasks.

A problem however exists in that such optimization efforts are inherently flawed because each only accounts mathematically for the tasks to be performed and the process resources (e.g., hardware, software, databases, communication/connectivity resources, transportation resources, facilities, utilities, inventories, etc.) to resolve the same, thereby failing to model and factor into the optimization effort human resources (i.e., services, functions, activities, skills, qualifications, task preferences, track records and the like perform by human beings) that ultimately utilize the process resources to resolve the tasks. Conventional approaches therefore exhibit poor response to emergency situations or extreme circumstances, and as such fail to provide a cooperative approach that optimizes not only process resources, but also human resources. What is needed in the art is a powerful and flexible means for dynamically optimizing processes as a whole in a real-time mode through allocation of both process resources and human resources among a plurality of tasks within a process system.

Put another way, the ultimate measurement of an implemented process system is how quickly the demands of requesting tasks can be satisfied through the allocation of process (and needed, but unallocated, human) resources. Today, even though “human resources” are on-site and ready to assist in the allocation of process resources to such requesting tasks, decisions to allocate the human resources are controlled largely by management (whether human management based upon periodic (e.g., daily, weekly, monthly or, even, quarterly) reports, or automated management based upon periodic batched data, or some combination of the two) based upon aged data management reacts based upon stale data, rather than reacting dynamically.

Therefore, a further need exists for a process system/management interface through which management could react more timely relative to conventional systems based upon dynamic data, and, in the event that management does not respond timely to a request of a particular task, the process system would undertake the steps necessary for allocation of both process resources and human resources to such task.

### SUMMARY OF THE INVENTION

To address the above-discussed deficiencies of the prior art, it is a primary object of the present invention to provide systems, as well as methods of operating the same, for allocating a plurality of resources, both process and human resources, among a plurality of tasks within a process system. Broadly, such systems and methodologies enable real-time process automation through mathematical modeling of human resources (i.e., services, functions, activities, skills, qualifications, task preferences, track records and the like perform by human beings) and process resources (e.g., hardware, software, databases, communication/connectivity resources, transportation resources, facilities, utilities, inventories, etc.), and then allocating ones of such resources to perform various tasks within the process system. It should be noted that such systems and methodologies may be suitably arranged to maintain a knowledge database and to modify the same to record past experiences thereby enabling the same to be self-learning.

In accord with the principles of the present invention, a resource allocator is introduced that is operable to allocate a plurality of resources among a plurality of tasks within a process system, wherein the plurality of resources includes both human resources and process resources and wherein the process system includes a plurality of application processes. The resource allocator includes a memory, a status-monitoring controller, and a resource allocation controller.

An exemplary memory in accord herewith is operable to store a model of the process system, wherein the model (i) represents mathematically the plurality of application processes, the plurality of resources, and the plurality of tasks, and (ii) defines various relationships among related ones thereof (e.g., application processes, resources, tasks, etc.). An exemplary status-monitoring controller in accord herewith is operable to monitor measurable characteristics associated with ones of the process system, the application processes, the resources, and the tasks. An exemplary resource allocation controller in accord herewith, and in response to ones of the monitored measurable characteristics, is operable to: (i) modify ones of the mathematical representations and (ii) allocate ones of the resources among ones of the tasks within the process system. In a related embodiment, a suitably arranged graphical user interface (“GUI”) is associated with the process system. The GUI is operable to transform real-time process system information into an audio or a visual format to enable supervisor (i.e., human management, system management (self-learning or otherwise), or some suitable combination of human and system management) interaction.

Before undertaking a DETAILED DESCRIPTION OF THE INVENTION, it may be advantageous to set forth a definition of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, coupled to or with, be communicable with, cooperate with, interleave, juxtapose, be proximate to, be bound to or with, have, have a property of, or the like; the term “memory” means any storage device, combination of storage devices, or part thereof whether centralized or distributed, whether locally or remotely; and the terms “controller” and “allocator” mean any device, system or part thereof that controls at least one operation, such a device, system or part thereof may be implemented in hardware, firmware or software, or some combination of at least two of the same. It should be noted that the functionality associated with any particular controller or allocator may be centralized or distributed, whether locally or remotely. In particular, a controller or allocator may comprise one or more data processors, and associated input/output devices and memory that execute one or more application programs and/or an operating system program. Additional definitions for certain words and phrases are provided throughout this patent document, those of ordinary skill in the art should understand that in many, if not most instances, such definitions apply to prior, as well as future uses of such defined words and phrases.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, and the advantages thereof, reference is not made to the following descriptions taken in conjunction with the accompanying drawings, wherein like numbers designate like objects, and in which:

FIG. 1 illustrates an exemplary process system and associated resource allocator in accordance with the principles of the present invention;

FIG. 2 illustrates a block diagram of a process system implemented as an information management system associated with the resource allocator of FIG. 1, all in accordance with the principles of the present invention;

FIG. 3 illustrates a block diagram of a network infrastructure utilized to implement a distributed embodiment of the process system of FIGS. 1 and 2 in association with a centralized implementation of resource allocator, all in accordance with the principles of the present invention;

FIG. 4 illustrates a block diagram of a data repository infrastructure utilized to implement an advantageous embodiment of the process system of FIGS. 1 to 3 in association with a graphical user interface, all in accordance with the principles of the present invention; and

FIG. 5 illustrates a flow diagram of an exemplary method of operating the process system of FIGS. 1 to 4 in accordance with the principles of the present invention.

### DETAILED DESCRIPTION OF THE INVENTION

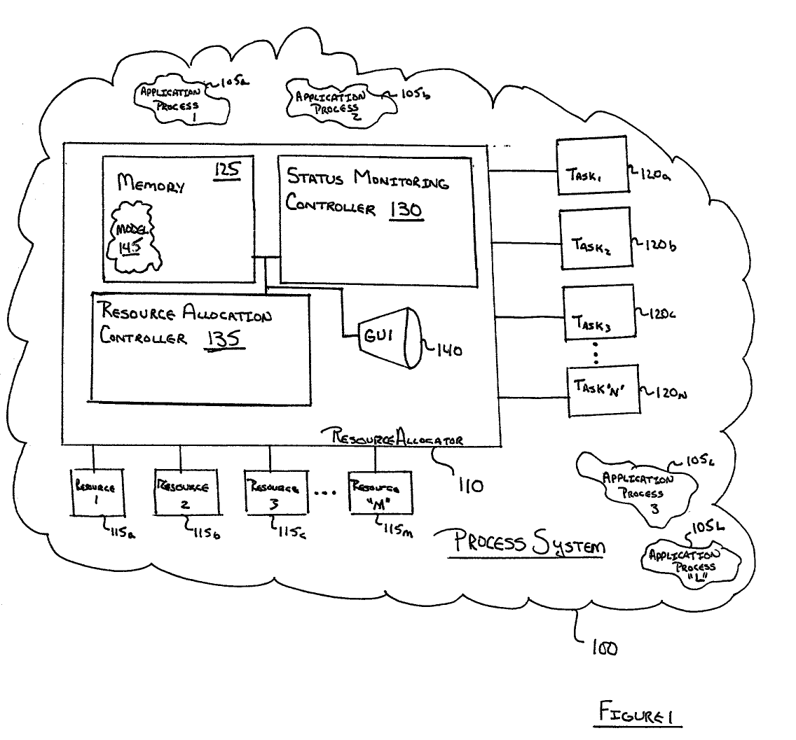

FIGS. 1 through 5, discussed below, and the various embodiments used to describe the principles of the present invention in this patent document, are by way of illustration only and should not be construed in any way to limit the scope of the invention. Those skilled in the art will understand that the principles of the present invention may be implemented in any suitably arranged system, as well as method of operating the same, for allocating a plurality of resources, both process and human resources, among a plurality of tasks within a process system.

Turning initially to FIG. 1, illustrated is an exemplary process system (generally designated 100, that includes a plurality of application processes 105; for purposes hereof, “application process” is defined broadly as a program or a part of a program that can execute, whether independently of other parts or not, and is designed for or to meet the needs of the process system 100—an application process may suitably consist of low-, mid- or high-level programs or parts thereof that interact with process system 100) that is associated with a resource allocator (generally designated 110), all in accordance with the principles of the present invention. For purposes hereof, the phrase “process system” means any computer processing system, network of computer processing systems, or portion thereof that is operable to monitor, control or otherwise supervise a process (e.g., information management system, manufacturing plant, refinery, hotel, restaurant, traffic control, transportation control, emergency services (e.g., police, fire, medical, military, etc.), and the like). According to one advantageous embodiment hereof, process system 100 is a service automation system that is operable to handle multiple and varied customer service systems with web-based, real-time, visualized, intelligent (i.e., self-learning), and control enhancements for industries that require timely delivery of services and resources.

Exemplary resource allocator 110 is operable to allocate a plurality of resources 115 among a plurality of tasks 120 within process system 100, wherein exemplary resources 115 include both human resources and process resources. According to one advantageous embodiment hereof, resource allocator 110 is a general processor that is operable to accept variable service requests and to intelligently apply the required resources to address such requests. Resource allocator 110 illustratively includes a memory 125, a status monitoring controller 130, a resource allocation controller 135 and is associated with a graphical user interface (“GUI,” which provides graphical information controls) 140, which cooperatively offer enhancements of real-time, visual, intelligent, and control functions through web-base connectivity.

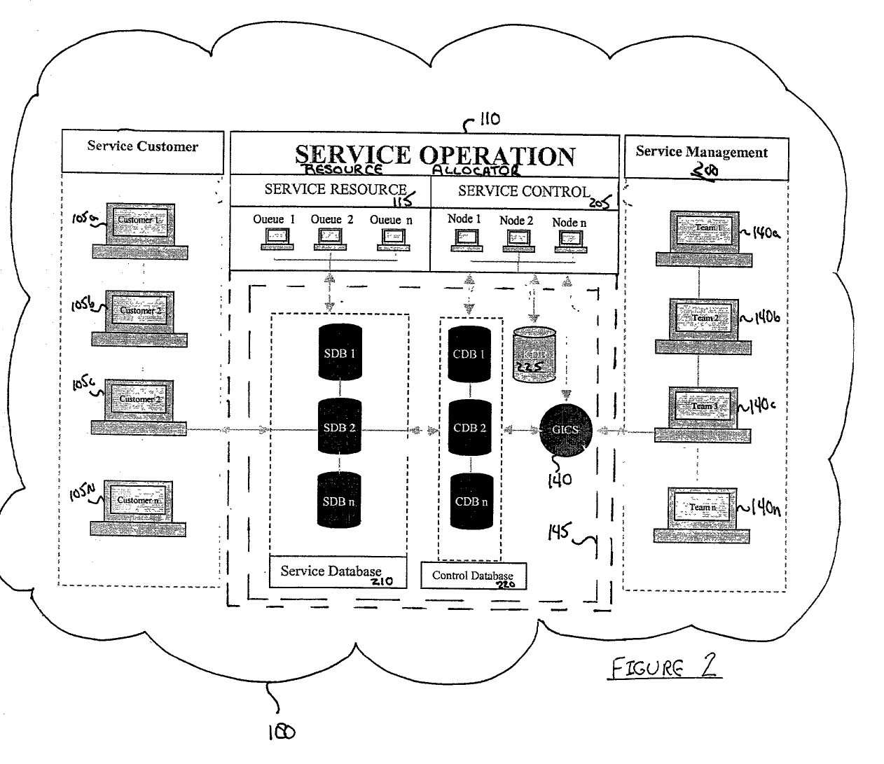

Exemplary memory 125 is operable to store a model 145 of process system 100. Exemplary model 145 represents mathematically application processes 105, resources 115, and tasks 120, and also defines various relationships among related ones of application processes 105, resources 115, and tasks 120. According to one advantageous embodiment hereof, memory 125 includes three databases (shown in FIG. 2), namely, a service database, a control database and a knowledge database. The service database is operable to store information regarding customers, networks, transactions, resources, and communications. The control database is operable to store algorithms, rules, and key elements for decision-making. The knowledge database is operable to provide task related intelligent information to help make optimal decisions, and to acquire and accumulate experience through evaluating results (i.e., artificial intelligence, expert system analysis, neural networks, etc.).

Exemplary status monitoring controller 130 is operable to monitor measurable characteristics associated with ones of process system 100, application processes 105, resources 115, and tasks 120. According to one advantageous embodiment hereof, status-monitoring controller 130 is a real-time monitor of updated status of resources, transactions, tasks, and enables human interaction online with other subsystems, allowing a human interface to update or over-ride the decision-making processes.

Exemplary resource allocation controller 135 is responsive to ones of the monitored measurable characteristics and is operable to: (i) modify ones of the mathematical representations of application processes 105, resources 115, tasks 120, and the defined relationships among related ones of application processes 105, resources 115, and tasks 120; and (ii) allocate ones of resources 115 among ones of tasks 120 within process system 100.

According to one advantageous embodiment hereof, resource allocation controller 135 is operable to interact with available resources and service requests (e.g., tasks) to generate and manage the required service transaction (noting, for instance, that measurable characteristics of resource allocation controller 135 may be associated with management of customers, networks, transactions, resources, and communications, such as service objectives, metrics, and measurements).

Exemplary GUI 140 is a user interface that is operable to transform real-time process system information into an audio or visual format to enable supervisory interaction. According to one advantageous embodiment hereof, GUI 140 is operable to visualize the data and status of external resources, service requests as well as on-going transactions by using graphic displays, audio/video equipment to provide real-time status as well as historical and statistical information with human interaction.

It should be noted that the principles of the present invention are described with reference to FIGS. 2 to 4 introduce an information management system embodiment of process system 100 of FIG. 1. Exemplary information management system 100 is introduced by way of illustration only to describe the principles of the present invention and should not be construed in any way to limit the scope of the invention. Turning next to FIG. 2, illustrated is a conceptual block diagram of information management system 100 associated with a service operation resource allocator 110, all in accordance with the principles of the present invention. Exemplary information management system 100, in addition to service operation resource allocator 110, includes a plurality of application processes 105, namely, a service customer block, and a service management block.

Exemplary service customer block may be a person or a controller; for instance, service customer block may suitably be a person using a computer that is associated with an intranet or the Internet, or it may be an intelligent input/output device associated with equipment to send and receive data using connectivity.

Exemplary service management block includes a plurality of GUIs 140 that provide user interfaces operable to transform real-time information into an audio or visual format to enable supervisory interaction. Service management block is operable to enable supervisory interaction with flexibility to visualize and control the entire service process flexibly (in a related embodiment, such supervisory interaction may suitably be in detail or in general with zoom in/out functions in a real-time mode).

Exemplary service operation block 110 is a resource allocator that is operable to allocate a plurality of service resources 115 among a plurality of tasks 120 within information management system 100. Service resources 115 include both human resources and process resources. According to this embodiment, the human resources may suitably be classified into three categories, namely, operation, administration and management. Exemplary human operation resources include service staff that work with customers or service requests, such as waiters, mechanics, plumbers, painters, electricians, soldiers, technicians, engineers, etc. Exemplary human administration resources include service coordinators, system operators and administrators that support the operations, such as accountants, purchase agents, auditors, receptionists, secretaries, controllers, servicemen, network administrators, etc. Exemplary human management resources include service managers, system managers, and operation managers that manage the process and sub-process systems and make business and operation decisions, such as it managers, police chiefs, hotel managers, restaurant managers, store managers, officers, executives, etc.

The process resources may suitably be classified into eight categories, namely, hardware, software, databases, communication/connectivity resources, transportation resources, facilities, utilities, and inventories. Exemplary hardware resources include computers, network devices such as switches/routers/hubs, digital/analog sensors, cables, meters, monitors, scopes, audio/video devices, special service tools, etc. Exemplary software resources include operation systems, network systems, database systems, application programs, graphics interfaces, system utilities, special applications such as artificial intelligence, neural net, system control and data acquisition (“SCADA”), etc.

Exemplary data resources include three databases, namely, (i) service databases 210 that maintains service objects (customers/equipment), service transactions, networks, resources, and communications, (ii) control databases 220 that maintains key attributes, algorithms, instructions, mathematics and rules that manage, monitor and control the operations, and (iii) knowledge databases 225 that maintain on-going real-time knowledge, information and experiences compiling for resource retention and self-learning process.

Exemplary communication/connectivity resources include local-area and wide-area networks, Internet, telephones/facsimile, mail, etc. Exemplary transportation resources include trucks, cars, boats, airplanes, bikes, motorcycles, railroads, space shuttles, balloons, military vehicles, etc. Exemplary technology resources include service automation technology that combines major technology areas, namely, (i) network technologies in office automation, (ii) human machine interface (“HMI”) technologies in industrial automation, and (iii) artificial intelligent technologies. Exemplary facilities resources include computer control/monitor/server rooms, labs, workrooms, offices, towers/antenna, machines/tools, piping, etc. Exemplary utilities resources include electricity, water, fuel, air, chemicals, etc. Exemplary inventory resources include supplies, materials, peripherals, components, ammunition, etc.

An important aspect of the illustrated embodiment is that service operation block 110 provides systematic operation with automatic and responsive control of service activities based on real-time service data and built-in intelligent decisions from model 145 of FIG. 1. Routine decisions are made by service automation while service operations are on going. The management is able, via GUIs 140, to make responsive decisions and allocate or utilize service intelligently based on the real-time graphics-enhanced information.

Service operation block 110 is illustratively associated with a plurality of service resources 115 and a plurality of service controls 205. Exemplary service resources 115 may suitably include people, hardware, software, information or facilities, all of which are to be applied to service activities. Exemplary service controls 205 may suitably include status monitoring controller 130, resource allocation controller 135, and model 145, all of FIG. 1, that work cooperatively to automatically issue service instructions according to defined rules of model 145.

Service control 205 therefore monitors and controls the service resource allocation and utilization as well as service level and matrix for the service operation. Model 145 of service control 205 again represents mathematically service customer 105, service resources 115, and tasks 120, and also defines various relationships among related ones of the same, and includes a service database 210, a control database 220 and knowledge database 225. Any suitably arranged mathematical representation may be used for model 145 or, for that matter, any of the measurable characteristics. Those skilled in the art will readily recognize that such mathematical representations will often be application dependent.

Exemplary service database 210 is operable to store real-time information regarding service customers 105 and service activities. Service database 210 provides information of service activities to service resources 115 through a plurality of service queues 120. Service database 210 also feeds real-time information to control database 220. According to the present embodiment, service database 210 may suitably be a relational database with flat file structure containing data in a two-dimensional table format. Exemplary control database 220 is operable to store consolidated real-time key attributes of information from service database 210 and also stores pre-defined algorithms (instructions and rules associated with status monitoring controller 130 and resource allocation controller 135) in a proper format. Instructions can be automatically executed according to the rules and real-time key attributes through HMI/SCADA control software. Service control 205 works with control database 220 to carry out defined instructions through HMI/SCADA software. According to the present embodiment, control database 220 is a data file with special format that contains key data and algorithms (instructions and rules associated with status monitoring controller 130 and resource allocation controller 135).

Exemplary knowledge database 225 is operable as a central repository of knowledge data, capturing qualitative and quantitative information to develop standards of performance in activities that are common regardless of industry. Knowledge data that would serve as a reference point for performance and procedural improvement to provide task related intelligent information used to make decisions optimally, and to acquire and accumulate experience through evaluating results (i.e., artificial intelligence, expert system analysis, neural networks, etc.).

An important aspect of the illustrated embodiment is that control database 220 serves to provide information service management with visual, intelligent, and control enhancements based on real-time information. In summary, using service database 210, control data base 220 and knowledge database 225, service operation block 110 is operable to allocated a plurality of service resources 115 among a plurality of tasks within information management system 100, and, more specifically, service operation block 110 utilizes a status monitoring controller and a resource allocation controller embodied on databases 210 and 220 in accord with the principles hereof.

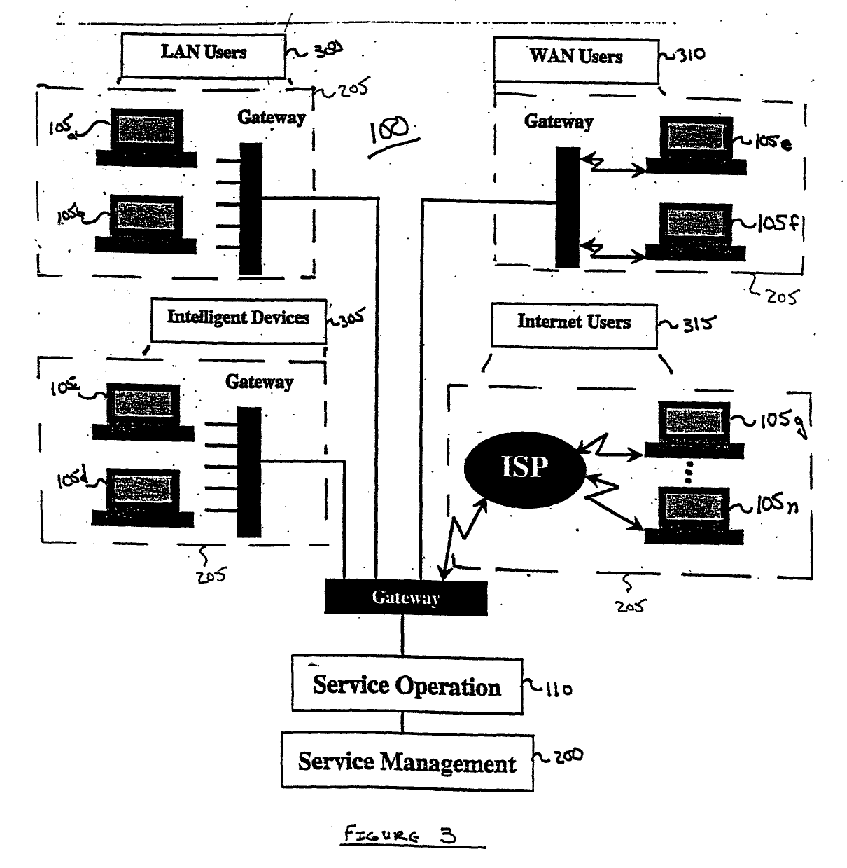

Turning now to FIG. 3, illustrated is a conceptual block diagram of an exemplary network infrastructure utilized to implement a distributed embodiment of process system 100 in association with a centralized implementation of service operation resource allocator 110. Exemplary distributed process system 100 includes a plurality of customers 105, including LAN users 300, intelligent devices 305 (e.g., personal data assistants (“PDAs”), two-way messaging devices, etc.), WAN users 310, Internet users 315, and the like. Those of ordinary skill in the art will recognize that this embodiment and other functionally equivalent embodiments may suitably be implemented by a variety of methods using many different computer, or processing, system platforms. Conventional computer and processing system architecture is more fully discussed in Computer Organization and Architecture, by William Stallings, MacMillan Publishing Co. (3^{rd} d. 1993); conventional processing system network design is more fully discussed in Data Network Design, by Darren L. Spohn, McGraw-Hill, Inc. (1993); and conventional data communications is more fully discussed in Data Communications Principles, by R. D. Gitlin, J. F. Hayes and S. B. Weinstein, Plenum Press (1992) and in The Irwin Handbook of Telecommunications, by James Harry Green, Irwin Professional Publishing (2^{nd} ed. 1992). Each of the foregoing publications is incorporated herein by reference for all purposes.

Broadly, process system 100 allocates a plurality of process and human resources among a plurality of tasks thereby enabling real-time process automation through mathematical modeling of the human resources and the process resources, and then allocating ones of such resources to perform various tasks within the process system. For the purposes of the illustrated embodiment, tasks are divided into three categories, namely, service requests, service dispatches and information sharing. A service request may suitably be stored in service databases 210 with priority, location, contents, requirements, contacts, etc. A service dispatch may suitably be stored in control databases 220 and knowledge databases 225 with service level objectives, service metrics/measurements, transaction/actions, status and situations, decision-making processes with real-time responsive, pre-defined, programmed, intelligent, knowledge/experience retention and self-learning characters. Information sharing is a request for computer generated audio/video and print report, e-based, real-time, graphical/visualized, etc.

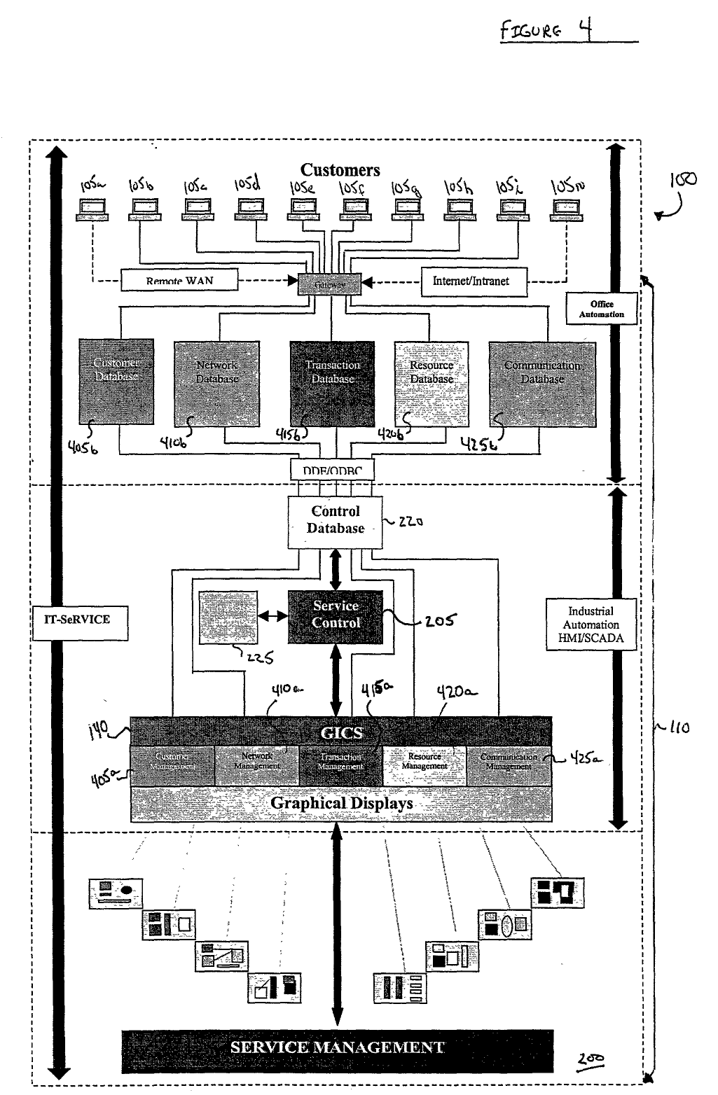

Turning now to FIG. 4, illustrated is a conceptual block diagram of a block diagram of an exemplary data repository infrastructure utilized to implement an embodiment of process system 100 and resource allocator/service operation block 110 in association with GUI 140. According to the present embodiment, real-time service information data is obtained and consolidated into control database 220. Exemplary service operation block 110 includes, among other elements, a resource allocation controller 135, which graphical information control system. Again, resource allocation controller 135, which is responsive to the monitored measurable characteristics of process system 100, is operable to modify ones of the mathematical representations of service customers 105, service resources 115, service tasks 120, and the defined relationships among related ones of the same; to allocate ones of service resources 115 among ones of tasks 120 within process system 100; and to provide a graphical presentation of the service processes.

Graphical information control system 140 of resources allocation controller 135 provides customer management 405a, networking management 410a, transaction management 415a, resource management 420a, and communication management 425a.

With respect to customer management 405a, information associated with computer users and equipment is stored on-line in a customers database 405b. Customer information may suitably be updated either by service personnel, other related databases, or by software utilities, which are operable to collect equipment configuration and utilization in real-time mode. Customer database 405b is illustratively dynamically linked with control database 220 through DDE/ODBC. Customer information may suitably be graphically displayed for management presentation, evaluation, and control.

With respect to network management 410a, information associated with network connectivity and devices is stored in a network database 410b through network servers and/or intelligent gateway devices. Smart network devices in conjunction with network utility software may suitably monitor and interrogate the network infrastructure providing real-time connectivity information. This information may also dynamically linked with control database 220 through DDE/ODBC. The network infrastructure and utilization are then graphically displayed to management in the same way as the customer information.

With respect to transaction management 415a, information associated with service transactions generated by customers and the system may suitably be stored on-line in a transaction database 415b. This transaction information is also dynamically linked with the control database 220 through DDE/ODBC. Consolidated transaction information may be graphically displayed to management.

With respect to resource management 420a, information associated with service resources is compiled in a resource database 420b. The service resources information is also dynamically linked to the control database 220 through DDE/ODBC. The available service resources will be automatically applied to address the service needs according to the predefined instructions and rules. The allocation and utilization of service resources may be graphically displayed to management. Resources such as personnel, hardware, software, information, or facilities to be used in the service may suitably be visualized under resource management.

With respect to communications management 425a, information associated with the customers, service operation and management is compiled in a communication database 425b. This information is also dynamically linked to the control database 220 through DDE/ODBC. Graphical information control system of resource allocation controller 135 may then execute automatic communication actions between customers, service operation and management based on the communication instructions and rules set in control database 220. The communication activities may be displayed to management in real-time mode automatically.

An important aspect of the present embodiment is that communications may suitably be accomplished through telephone, two-way pager, Win 911, RF wireless, or e-mail, which would allow service personnel to access service management and customers.

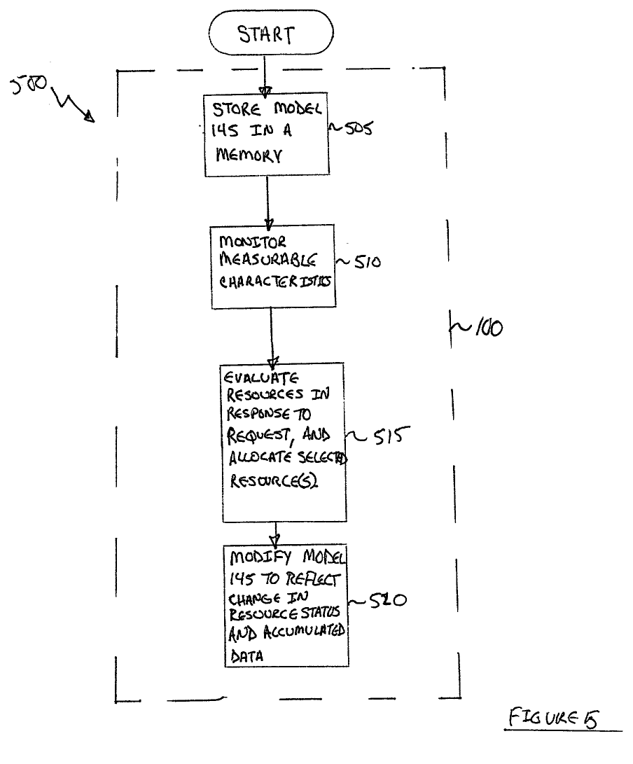

Turning next to FIG. 5, illustrated is a flow diagram (generally designated 500) of an exemplary method of operating process system 100 of FIGS. 1 to 4, all in accord with the principles of the present invention. For purposes of illustration, concurrent reference is made to embodiment disclosed with reference to FIG. 2. It is beneficial to assume that process system 100 is instantiated and fully operational, and for illustrative purposes directed to a raw material refining environment. Further, for simplicity, assume that there are two human resources available and a plethora of process resources. Thus, exemplary process system 100 controls processing raw materials, and likely controls a control center and associated process stages (not shown; e.g., application processes 105).

A first process stage might include raw material grinders that receive a feed of raw material and grind the same, such as by using a pulverizer or a grinding wheel, into smaller particles of raw material. A second process stage might include a washer that receives the ground raw materials and cleans the same to remove residue from the first stage. A third process stage might include separators that receive the ground, washed raw materials and separate the same into desired minerals and any remaining raw materials. Since this process system and related facility are provided for purposes of illustration only and the principles of such a facility are well known, further discussion of the same is beyond the scope of this patent document and unnecessary.

To begin, resource allocator 110 stores a model 145 of process system 100 in memory (process step 505), model 145 representing mathematically the human resources, the process resources, the application processes 105 (i.e., the control for the grinders, separators and washers, etc.), and relationships among related ones thereof. Resource allocator 110 then monitors these measurable characteristics and receives service requests (process step 510), and, for the present example, from a particular grinder.

In response to measurable characteristics causing a request for service of the subject grinder, resource allocator 110 evaluates the human resources and allocates one to service the grinder, along with process resources that may be necessary and appropriate to complete the same (process step 515). Resource allocator 110, in response to the servicing of the task, modifies ones of the mathematical representations, first indicating that the human resource is occupied and second indicating the quality with which the task was completed (process step 520).

According to the illustrated embodiment, resource allocator 110 modifies knowledge database 225 to provide updated task related information to help make future decisions concerning the grinder, the allocated human resource, etc., both intelligently and optimally. Resource allocator 110 thereby acquires and accumulates experience through evaluating results (i.e., artificial intelligence, expert system analysis, neural network analysis, etc.). Thus, in a later scenario, should this same human resource be otherwise occupied with another task and this grinder requires a similar service, resource allocator 110 can suitably utilize dynamic knowledge database 225 evaluate available human resources to decide whether to reallocate this same human resource to the grinder based upon past experience recorded in the associated measurable characteristics and to allocate another human resource to the task left uncompleted. Again, resources, both human and process, are re-usable, re-directable for “next” requests through intelligent decision making sub-process of experience accumulation, analysis, optimization and self-learning. Knowledge database 225 operates as a central repository of knowledge data, capturing qualitative and quantitative information to develop standards of performance in activities that are common regardless of industry.

In conclusion, and in summary, it is readily apparent that systems, as well as methods of operating the same, are disclosed herein for allocating a plurality of resources, both process and human resources, among a plurality of tasks within a process system. An exemplary resource allocator has been introduced that is operable to allocate a plurality of resources among a plurality of tasks within a process system, wherein the process system includes a plurality of application processes. The resource allocator includes a memory, a status-monitoring controller, and a resource allocation controller. An exemplary memory in accord herewith is operable to store a model of the process system, wherein the model (i) represents a mathematically the plurality of application processes, the plurality of resources, and the plurality of tasks, and (ii) defines various relationships among related ones thereof. An exemplary status-monitoring controller in accord herewith is operable to monitor measurable characteristics associated with ones of the process system, the application processes, the resources, and the tasks. An exemplary resource allocation controller in accord herewith, and in response to ones of the monitored measurable characteristics, is operable to: (i) modify ones of the mathematical representations and (ii) allocate ones of the resources among ones of the tasks within the process system. It should be noted that any resource, whether human or process, that is allocated to a task may suitably be reallocated to another task in short, resources are re-usable, re-directable for “next” requests through intelligent decision making sub-process of experience accumulation, analysis, optimization and self-learning.

Although the present invention has been described in detail, those skilled in the art should understand that they can make various changes, substitutions and alterations herein without departing from the spirit and scope of the invention in its broadest form.

What is claimed is:

1. A resource allocator that is operable to allocate a plurality of resources among a plurality of tasks within a process system, said plurality of resources comprising human resources and process resources, and said process system comprising a plurality of application processes, said resource allocator comprising:
a memory that stores a model of said process system, said model representing mathematically said plurality of application processes, said plurality of resources, and said plurality of tasks, and defining relationships among related ones thereof;
a status monitoring controller that monitors measurable characteristics associated with ones of said process system, said plurality of application processes, said plurality of resources, and said plurality of tasks; and
a resource allocation controller that modifies ones of said mathematical representations and that allocates ones of said plurality of resources among ones of said plurality of tasks within said process system in response to ones of said monitored measurable characteristics.

2. The resource allocator as set forth in claim 1 further comprising a graphical user interface that is operable to enable supervisory interaction.

3. The resource allocator as set forth in claim 2 wherein said graphical user interface is operable to facilitate at least one of customer management, network management, transaction management, resource management, communication management.

4. The resource allocator as set forth in claim 1 wherein said memory further comprises a data repository that comprises at least one of a customer database, a network database, a transaction database, a resource database, a communication database, a knowledge database and a control database.

5. The resource allocator as set forth in claim 4 wherein said data repository comprises at least said knowledge database, said resource allocator is further operable to modify said knowledge database in response to ones of said monitored measurable characteristics thereby enabling said resource allocator to be self-learning.

6. The resource allocator as set forth in claim 1 wherein said resource allocation controller is operable to reselect one of said allocated ones of said plurality of resources among ones of said plurality of tasks within said process system in response to modified ones of said monitored measurable characteristics.

7. A method of operating a resource allocator to allocate a plurality of resources among a plurality of tasks within a process system, said plurality of resources comprising human resources and process resources, and said process system comprising a plurality of application processes, said method of operating said resource allocator comprising the steps of:
storing a model of said process system in memory that represents mathematically said plurality of application processes, said plurality of resources, and said plurality of tasks, and defining relationships among related ones thereof;
monitoring measurable characteristics associated with ones of said process system, said plurality of application processes, said plurality of resources, and said plurality of tasks in said memory; and
modifying ones of said mathematical representations and allocating ones of said plurality of resources among ones of said plurality of tasks within said process system in response to ones of said monitored measurable characteristics.

8. The method of operating the resource allocator as set forth in claim 7 further comprising the step of providing a graphical user interface operable to enable supervisory interaction, to facilitate at least one of customer management, network management, transaction management, resource management, communication management.

9. The method of operating the resource allocator as set forth in claim 7 further comprising the step of maintaining at least one of a customer database, a network database, a transaction database, a resource database, a communication database, a knowledge database and a control database in memory.

10. The method of operating the resource allocator resource allocator as set forth in claim 9 wherein said knowledge database is maintained in memory and said method further comprises the step of modifying said knowledge database in response to ones of said monitored measurable characteristics thereby enabling said resource allocator to be self-learning.

11. The method of operating the resource allocator as set forth in claim 7 further comprising the steps of reselecting one of said allocated ones of said plurality of resources among ones of said plurality of tasks within said process system in response to modified ones of said monitored measurable characteristics.

12. The method of operating the resource allocator as set forth in claim 11 wherein said reselecting step further comprises the step of accessing at least a knowledge database.

13. A process system comprising:
a plurality of subsystems;
a plurality of tasks;
a plurality of resources comprising human resources and process resources; and
a resource allocator that is operable to allocate said plurality of resources among said plurality of tasks, said resource allocator comprising:
a memory that stores a model of said process system, said model representing mathematically said plurality of application processes, said plurality of resources, and said plurality of tasks, and defining relationships among related ones thereof;
a status monitoring controller that monitors measurable characteristics associated with ones of said process system, said plurality of application processes, said plurality of resources, and said plurality of tasks; and
a resource allocation controller that modifies ones of said mathematical representations and that allocates ones of said plurality of resources among ones of said plurality of tasks within said process system in response to ones of said monitored measurable characteristics.

14. The process system as set forth in claim 13 wherein said resource allocator further comprises a graphical user interface that is operable to enable supervisory interaction.

15. The process system as set forth in claim 14 wherein said graphical user interface is operable to facilitate at least one of customer management, network management, transaction management, resource management and communication management.

16. The process system as set forth in claim 13 wherein said memory further comprises a data repository that comprises at least one of a customer database, a network database, a transaction database, a resource database, a communication database, a knowledge database and a control database.

17. The process system as set forth in claim 16 wherein said data repository comprises at least said knowledge database, said resource allocator is further operable to modify said knowledge database in response to ones of said monitored measurable characteristics thereby enabling said resource allocator to be self-learning.

18. The process system as set forth in claim 13 wherein said resource allocator is operable to reselect one of said allocated ones of said plurality of resources among ones of said plurality of tasks within said process system in response to modified ones of said monitored measurable characteristics.

19. The process system as set forth in claim 13 wherein said process system controls one of a manufacturing plant, a refinery, a hotel, a restaurant, a traffic control system, a transportation control system and an emergency services system.

20. The process system as set forth in claim 13 wherein said resource allocator is an information management system.
